(19) United States
(12) Patent Application Publication
(10) Pub. No.: US 2019/0287082 A1
(43) Pub. Date: Sep. 19, 2019

(54) METHOD FOR PROCESSING TRANSACTIONS USING BLOCKCHAIN NETWORKS, AND TRANSACTION MANAGEMENT SERVER USING THE SAME

(71) Applicant: WAY2BIT Co. Ltd., Seongnam-si (KR)

(72) Inventors: Gyehan SONG, Seongnam-si (KR); Igoo LEE, Seoul (KR); Seoho RYU, Seoul (KR)

(73) Assignee: WAY2BIT Co. Ltd., Seongnam-si (KR)

(21) Appl. No.: 16/299,172

(22) Filed: Mar. 12, 2019

(30) Foreign Application Priority Data
Mar. 13, 2018 (KR) 10-2018-0029457

(51) Int. Cl. G06Q 20/06; G06Q 20/36; G06K 9/62; H04L 9/06

(52) U.S. Cl. CPC G06Q 20/0658; G06Q 20/3672; H04L 2209/38; H04L 9/0637; G06K 9/6267

(57) ABSTRACT

A method of handling transactions using blockchain networks is provided. The method includes steps of: a transaction-managing server (a) if requests for registering transactions are acquired, confirming each validity of each of said transactions and queueing each of said transactions in case it is determined as valid; (b) classifying the queued transactions such that each of the queued transactions corresponds to each of the blockchain networks per each of channels; and (c) by transmitting each of the classified queued transactions to each of the blockchain networks, instructing each of the blockchain networks to convert the classified queued transactions per each of the channels into one representative transaction per each of the channels, and if a distributive consensus on the converted representative transaction is reached, allowing one block including the classified queued transactions corresponding to said one representative transaction to be registered in one of distributed ledgers.

### CROSS-REFERENCE TO RELATED APPLICATION

The present application claims priority to Korean Patent Application 10-2018-0029457, filed Mar. 13, 2018, the entire contents of which are incorporated herein by reference.

### FIELD OF THE DISCLOSURE

The present disclosure relates to a method for handling transactions using blockchain networks; and more particularly, to the method for classifying and registering the transactions in the blockchain networks, and the server using the same.

### BACKGROUND OF THE DISCLOSURE

Recently, services have been provided which use a decentralized application platform, i.e., an application platform based on a blockchain network, as a solution for security problems due to forgery and hacking.

In particular, Internet-based commercial content services such as games and communities require massive and rapid transaction processing.

Therefore, in order to introduce the application platform based on the blockchain network, stakeholders are trying to solve a transaction performance problem in their own ways.

For example, in a case of a card game based on the blockchain network, whether transactions can be sufficiently accommodated when hundreds to thousands of games are operated at the same time has not yet been discussed. A typical card game lasts as long as 90 seconds on average and many transactions are made during the game, and hundreds of thousands of players can make these transactions at the same time. Thus performance that meets such service requests is required, but nobody has a clear answer yet.

Particularly, in a blockchain structure, it is necessary to sequentially process the transactions requested for registration. Therefore, while a processing of a specific transaction is being delayed, subsequent transactions cannot be processed, thereby disrupting the service.

That is, in the blockchain structure, the generated transactions must be stored in blocks in a time-sequential order so that a reliability of the transactions is ensured.

For example, in case a user 1 having 10 dollars transfers 5 dollars to a user 2, and then transfers 3 dollars to a user 3, a transaction 1 stores information representing that the user 1 initally having 10 dollars transfers 5 dollars to the user 2 and that the user 1 has remaining 5 dollars, and a transaction 2 stores information representing that the user 1 having 5 dollars transfers 3 dollars to the user 3 and that the user 1 has remaining 2 dollars. However, in case an order of the transaction 1 and the transaction 2 is changed, if the transaction 1 is performed after execution of the transaction 2, a logical error occurs because the user 1 having 2 dollars has to transfer 5 dollars to the user 2.

In addition, when providing various services in a single blockchain network, a speed of writing to the blockchain network may be slowed due to characteristics of service-specific transactions, and a failure occurring in a specific service affects other service channels. That is, when a registration transaction is delayed due to the failure of the specific service, registration of transactions from other services in the blockchain network may also be delayed.

In addition, when a security problem or a bug occurs in the specific service, it affects other services, resulting in a vulnerability of the whole system.

### SUMMARY OF THE DISCLOSURE

It is an object of the present disclosure to solve all the aforementioned problems.

It is another object of the present disclosure to provide a transaction processing technology capable of fast processing using a blockchain network when storing or registering transactions of services.

It is still another object of the present disclosure to provide a transaction processing method using the blockchain network capable of minimizing influence of one service on another service when rendering various services using a single crypto currency.

It is still yet another object of the present disclosure to provide the transaction processing method using the blockchain network, capable of reducing a total probability of failures in the blockchain network and preventing a bug or a security problem of a specific service from spreading to another service.

In accordance with one aspect of the present disclosure, there is provided a method for handling one or more transactions using one or more blockchain networks, including steps of: (a) a transaction-managing server, if one or more requests for registering one or more transactions are acquired, confirming each of one or more validities of each of said one or more transactions and queueing each of said one or more transactions in case it is determined as valid; (b) the transaction-managing server classifying the queued transactions to be registered in the blockchain networks such that each of the queued transactions corresponds to each of the blockchain networks per each of channels; and (c) the transaction-managing server, by transmitting each of the classified queued transactions to each of the blockchain networks per each of the channels, instructing each of the blockchain networks per each of the channels to convert at least one of the classified queued transactions per each of the channels into at least one representative transaction per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in at least one of distributed ledgers.

As one example, the step of (c) includes steps of: (c1) the transaction-managing server instructing each of the blockchain networks per each of the channels to convert at least one of the classified queued transactions per each of the channels into the representative transaction per each of the channels; (c2) the transaction-managing server instructing each of the blockchain networks per each of the channels to proceed with a process of the distributive consensus on the representative transaction per each of the channels; (c3) the transaction-managing server instructing each of the blockchain networks per each of the channels to convert the consensus-reached representative transaction per each of the channels into each of individual transactions; and (c4) the transaction-managing server instructing each of the blockchain networks per each of the channels to allow at least one block including at least one of the individual transactions to be registered in each of the distributed ledgers corresponding to said each of the blockchain networks per each of the channels.

As one example, at the step of (c1), the transaction-managing server converts the classified queued transactions per each of the channels into the representative transaction per each of the channels by either a unit of a certain time interval or a unit of a certain number of the classified queued transactions.

As one example, if each of the blockchain networks per each of the channels corresponds to each of different service servers providing each of different services, the transaction-managing server manages said one or more transactions such that said one or more transactions are linked with a single cryptocurrency accepted by each of the different service servers.

As one example, at the step of (a), the transaction-managing server performs at least part of (i) a format validation which determines each of first validities representing whether each of said one or more transactions has a format conforming to a certain protocol and (ii) a content validation which determines each of second validities representing whether each of contents in each of said one or more transactions is valid.

As one example, at the step of (b), the transaction-managing server, according to a result of the format validation, determines which of the queued transactions is to be stored in which of the blockchain networks per each of the channels and classifies the queued transactions by a unit of the channels.

As one example, the transaction-managing server stores, in a physically and logically distributive clustering structure, the classified queued transactions in a first storage part, and if an overflow occurs in the first storage part, physically stores the classified queued transactions in a second storage part.

In accordance with another aspect of the present disclosure, there is provided a method for handling one or more transactions using one or more blockchain networks, including steps of: (a) a transaction-managing server which functions as at least one of blockchain nodes, if one or more requests for registering one or more transactions are acquired, confirming each of one or more validities of each of said one or more transactions and queueing each of said one or more transactions in case it is determined as valid; (b) the transaction-managing server classifying the queued transactions to be registered in the blockchain networks such that each of the queued transactions corresponds to each of distributed ledgers per each of channels; and (c) the transaction-managing server converting at least one of the classified queued transactions per each of the channels into at least one representative transaction per each of the channels by referring to each of the classified queued transactions classified as corresponding to each of the distributed ledgers per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in each of the distributed ledgers per each of the channels.

As one example, the step of (c) includes steps of: (c1) the transaction-managing server converting at least one of the classified queued transactions per each of the channels into the representative transaction per each of the channels; (c2) the transaction-managing server proceeding with a process of the distributive consensus on the representative transaction per each of the channels; (c3) the transaction-managing server converting the consensus-reached representative transaction per each of the channels into each of individual transactions; and (c4) the transaction-managing server allowing at least one block including each of the individual transactions to be registered in each of the distributed ledgers per each of the channels corresponding to the block.

As one example, if each of the distributed ledgers per each of the channels corresponds to each of different service servers providing each of different services, the transaction-managing server manages said one or more transactions such that said one or more transactions are linked with a single cryptocurrency accepted by each of the different service servers.

As one example, at the step of (a), the transaction-managing server performs at least part of (i) a format validation which determines each of first validities representing whether each of said one or more transactions has a format conforming to a certain protocol and (ii) a content validation which determines each of second validities representing whether each of contents in each of said one or more transactions is valid.

As one example, at the step of (b), the transaction-managing server, according to a result of the format validation, determines which of the queued transactions is to be stored in which of the blockchain networks per each of the channels and classifies the queued transactions by a unit of the channels. In accordance with still another aspect of the present disclosure, there is provided a transaction-managing server for handling one or more transactions using one or more blockchain networks, including: at least one memory that stores instructions; and at least one processor configured to execute the instructions to perform or support another device to perform processes of: (I) if one or more requests for registering one or more transactions are acquired, confirming each of one or more validities of each of said one or more transactions and queueing each of said one or more transactions in case it is determined as valid, (II) classifying the queued transactions to be registered in the blockchain networks such that each of the queued transactions corresponds to each of the blockchain networks per each of channels, and (III) by transmitting each of the classified queued transactions to each of the blockchain networks per each of the channels, instructing each of the blockchain networks per each of the channels to convert at least one of the classified queued transactions per each of the channels into at least one representative transaction per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in at least one of distributed ledgers.

As one example, the process of (III) includes processes of: (III-1) instructing each of the blockchain networks per each of the channels to convert at least one of the classified queued transactions per each of the channels into the representative transaction per each of the channels, (III-2) instructing each of the blockchain networks per each of the channels to proceed with a process of the distributive consensus on the representative transaction per each of the channels, (III-3) instructing each of the blockchain networks per each of the channels to convert the consensus-reached representative transaction per each of the channels into each of individual transactions, and (III-4) instructing each of the blockchain networks per each of the channels to allow at least one block including at least one of the individual transactions to be registered in each of the distributed ledgers corresponding to said each of the blockchain networks per each of the channels.

As one example, at the process of (III-1), the processor converts the classified queued transactions per each of the channels into the representative transaction per each of the channels by either a unit of a certain time interval or a unit of a certain number of the classified queued transactions.

As one example, if each of the blockchain networks per each of the channels corresponds to each of different service servers providing each of different services, the processor manages said one or more transactions such that said one or more transactions are linked with a single cryptocurrency accepted by each of the different service servers.

As one example, at the process of (I), the processor performs at least part of (i) a format validation which determines each of first validities representing whether each of said one or more transactions has a format conforming to a certain protocol and (ii) a content validation which determines each of second validities representing whether each of contents in each of said one or more transactions is valid.

As one example, at the process of (II), the processor, according to a result of the format validation, determines which of the queued transactions is to be stored in which of the blockchain networks per each of the channels and classifies the queued transactions by a unit of the channels.

As one example, the processor stores, in a physically and logically distributive clustering structure, the classified queued transactions in a first storage part, and if an overflow occurs in the first storage part, physically stores the classified queued transactions in a second storage part.

In accordance with still yet another aspect of the present disclosure, there is provided a transaction-managing server, which functions as at least one of blockchain nodes, for handling one or more transactions using one or more blockchain networks, including: at least one memory that stores instructions; and at least one processor configured to execute the instructions to perform or support another device to perform processes of: (I) if one or more requests for registering one or more transactions are acquired, confirming each of one or more validities of each of said one or more transactions and queueing each of said one or more transactions in case it is determined as valid, (II) classifying the queued transactions to be registered in the blockchain networks such that each of the queued transactions corresponds to each of distributed ledgers per each of channels, and (III) converting at least one of the classified queued transactions per each of the channels into at least one representative transaction per each of the channels by referring to each of the classified queued transactions classified as corresponding to each of the distributed ledgers per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in each of the distributed ledgers per each of the channels.

As one example, the process of (III) includes processes of: (III-1) converting at least one of the classified queued transactions per each of the channels into the representative transaction per each of the channels, (III-2) proceeding with a process of the distributive consensus on the representative transaction per each of the channels, (III-3) converting the consensus-reached representative transaction per each of the channels into each of individual transactions, and (III-4) allowing at least one block including each of the individual transactions to be registered in each of the distributed ledgers per each of the channels corresponding to the block.

As one example, if each of the distributed ledgers per each of the channels corresponds to each of different service servers providing each of different services, the processor manages said one or more transactions such that said one or more transactions are linked with a single cryptocurrency accepted by each of the different service servers.

As one example, at the process of (I), the processor performs at least part of (i) a format validation which determines each of first validities representing whether each of said one or more transactions has a format conforming to a certain protocol and (ii) a content validation which determines each of second validities representing whether each of contents in each of said one or more transactions is valid.

As one example, at the process of (II), the processor, according to a result of the format validation, determines which of the queued transactions is to be stored in which of the blockchain networks per each of the channels and classifies the queued transactions by a unit of the channels.

Further, in accordance with one example embodiment of the present disclosure, a transaction-managing server for performing methods mentioned above is provided.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings, in which:

FIG. 1 is a drawing schematically illustrating a configuration of a transaction-managing server in accordance with one example embodiment of the present disclosure.

FIG. 2A is a drawing schematically illustrating a configuration of storing classified transactions per service in blockchain networks in accordance with one example embodiment of the present disclosure and FIG. 2B is a drawing schematically illustrating the configuration of FIG. 2A in a blockchain network structure in accordance with one example embodiment of the present disclosure.

FIG. 3 is a drawing schematically illustrating a blockchain architecture in accordance with one example embodiment of the present disclosure.

FIG. 4A is a drawing schematically illustrating a configuration of storing the classified transactions per service in the blockchain networks in accordance with another example embodiment of the present disclosure and FIG. 4B is a drawing schematically illustrating the configuration of FIG. 4A in the blockchain network structure in accordance with another example embodiment of the present disclosure.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

Identical reference numerals are for convenience of explanation but not intended for representing sameness of separate devices.

Throughout the present disclosure, every processor, every memory, every storage, or any other computing components are described as separate components, however, said every processor, said every memory, said every storage, or said any other computing components may be configured as a single device or any other combinations thereof.

To allow those skilled in the art to the present disclosure to be carried out easily, the example embodiments of the present disclosure by referring to attached diagrams will be explained in detail as shown below.

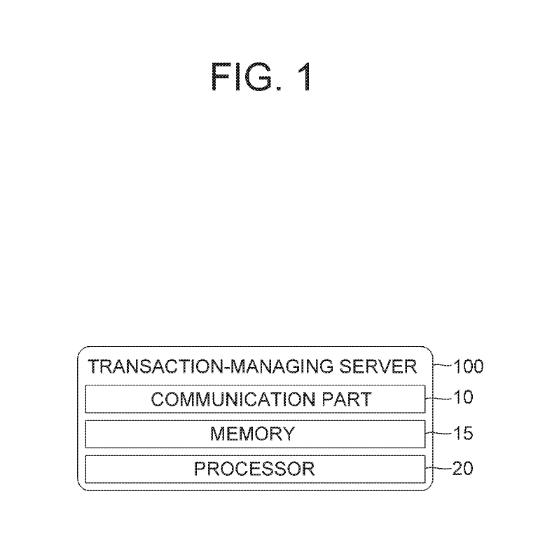

FIG. 1 is a drawing schematically illustrating a configuration of a transaction-managing server in accordance with one example embodiment of the present disclosure.

By referring to FIG. 1, the transaction-managing server 100 may manage one or more transactions in one or more blockchain networks and may include a communication part 10, a memory 15 for storing instructions to manage the transactions in the blockchain networks, and a processor 20 for performing processes to manage the transactions in the blockchain networks corresponding to the instructions in the memory 15. Further, according to another example embodiment of the present disclosure, the method may be performed by the transaction-managing server 100 or another server of a different configuration. Also, the transaction-managing server 100 may be servers corresponding to each of nodes in the blockchain networks, or may be a server managing each of the nodes in the blockchain networks, or may be a transaction server. In addition to this, the transaction-managing server 100 may be a server same as one of servers forming the blockchain networks, and may be an application logically running in the server.

The transaction-managing server 100 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

The communication part 10 of such devices may transmit requests to and receive responses from other linked devices. As one example, such requests and responses may be carried out by the same TCP session, but the scope of the present invention is not limited thereto. For example, they could be transmitted and received as UDP datagrams.

The processor 20 of such devices may include hardware configuration of MPU (Micro Processing Unit) or CPU (Central Processing Unit), cache memory, data bus, etc. Additionally, any OS and software configuration of applications that achieve specific purposes may be further included. And, the communication part 10 of the transaction-managing server 100 may receive one or more requests for registering one or more transactions from various external service companies, e.g., game-providing servers. And the processor 20 may perform or support another device to perform processes of (i) if the requests for registering said one or more transactions are acquired, confirming each of one or more validities of each of said one or more transactions and queueing each of said one or more transactions in case it is determined as valid, (ii) classifying the queued transactions to be registered in the blockchain networks such that each of the queued transactions corresponds to each of the blockchain networks per each of channels, and (iii) by transmitting each of the classified queued transactions to each of the blockchain networks per each of the channels, instructing each of the blockchain networks per each of the channels to convert at least one of the classified queued transactions per each of the channels into at least one representative transaction per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in at least one of distributed ledgers.

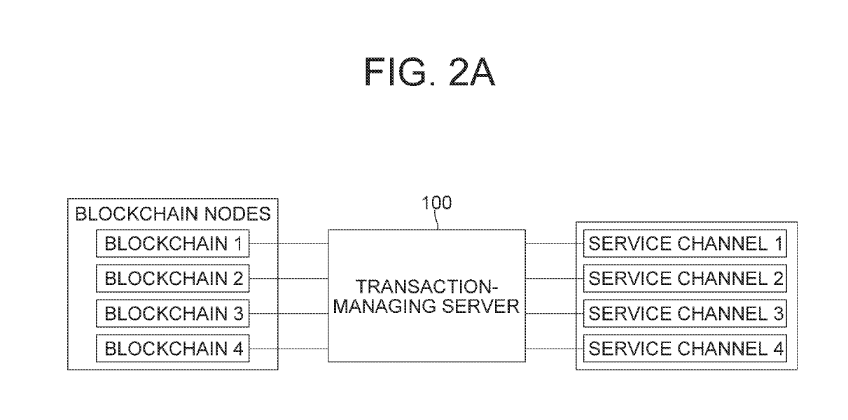

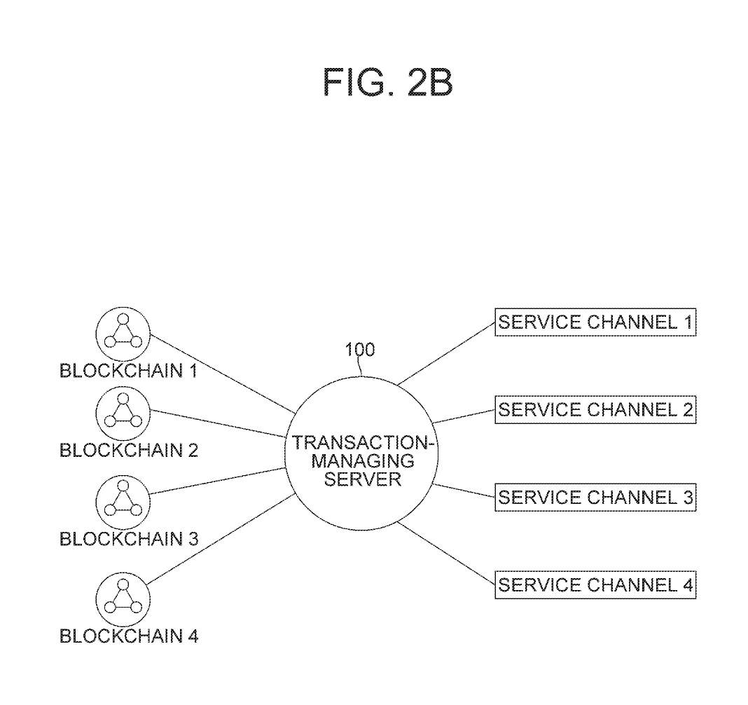

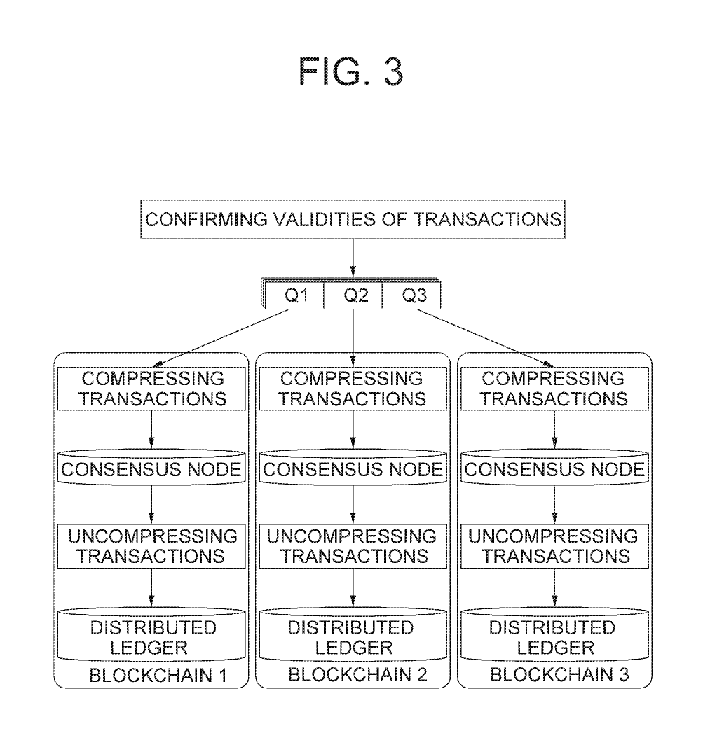

FIG. 2A is a drawing schematically illustrating a configuration of storing the classified queued transactions per service in the blockchain networks in accordance with one example embodiment of the present disclosure. FIG. 2B is a drawing schematically illustrating the configuration of FIG. 2A in a blockchain network structure. FIG. 3 is a drawing schematically illustrating a blockchain architecture in accordance with one example embodiment of the present disclosure. By referring to FIGS. 2A, 2B and 3, a transaction processing method using the blockchain networks through the processor 20 of the transaction-managing server 100 in accordance with the present disclosure is described in detail as follows. For reference, FIG. 3 shows the blockchain architecture that may also be applied to another example embodiment of the present disclosure which will be described later.

The transaction processing method in accordance with one example of the present disclosure proposes a method of recording the block including the classified queued transactions, i.e., the transactions per each of the channels, by using each of the separate blockchain networks for each of the services. Herein, the blockchain networks may be comprised of public blockchains or private blockchains. Also, although the blockchain networks are shown as separated for each of the services, that is, although each of the blockchain networks may match each of the services, the separation may also represent that the blockchain networks are separated according to characteristics of the transactions occurring in each of the services, or that a ledger of a single blockchain is divided, but the scope of the present disclosure is not limited thereto.

By referring to FIGS. 2A and 2B, the transaction-managing server 100 in accordance with the present disclosure may perform its function such that each of the independent blockchain networks per each of the channels, represented as a blockchain 1 to a blockchain 4, is allocated per each of service channels, represented as a service channel 1 to a service channel 4. That is, the transaction-managing server 100 in accordance with the present disclosure may classify the transactions as corresponding to each of the independent blockchain networks per each of the channels according to each of the requests from each of the different service channels, to thereby respectively record the transactions in each of the distributed ledgers of their corresponding blockchain networks per each of the channels.

However, although FIGS. 2A and 2B show an example of the transaction-managing server 100 recording the transactions per service channel in the blockchain networks per each of the channels, as another example, only the requests from a single service may be managed and the transactions of the single service may be recorded in each of the distributed ledgers of each of the blockchain networks per each of the channels corresponding to the different channels within the single service. In still another example, the transactions of the various services may be classified by characteristics, and the transactions may be recorded in the distributed ledgers of the blockchain networks per each of the channels corresponding to the classified characteristics of the transactions.

That is, if the requests for registering the transactions are acquired from one or more service channel servers which are servers of the service channel 1 to the service channel 4, the transaction-managing server 100 in accordance with the present disclosure may confirm each of the validities of each of the transactions. Herein, when confirming the validities of the transactions, the transaction-managing server 100 may classify the transactions which are determined as valid such that each of the valid transactions corresponds to each channel of the blockchain networks. As one example, the transaction-managing server 100 may sequentially generate, classify, and record queues of the transactions in a memory which is a temporary storage.

Then, by transmitting the classified queued transactions, classified as corresponding to the blockchain networks per each of the channels, to each of the blockchain networks per each of the channels, i.e., the blockchain 1 to the blockchain 4, the transaction-managing server 100 may instruct each of the blockchain networks per each of the channels to record each of the classified queued transactions by a unit of a transaction or a block in the distributed ledgers. Herein, each of the blockchain networks per each of the channels, i.e., the blockchain 1 to the blockchain 4, may convert at least one of the classified queued transactions per each of the channels into at least one representative transaction per each of the channels, e.g., compress said at least one of the classified queued transactions per each of the channels into at least one compressed transaction, and if the distributive consensus on the converted representative transaction per each of the channels is determined as reached, may allow (i) at least one block including said at least one of the classified queued transactions per each of the channels or (ii) each of the classified queued transactions per each of the channels corresponding to said at least one representative transaction per each of the channels to be registered in at least one of the distributed ledgers. Herein, if the representative transaction per each of the channels is the compressed transaction converted from said at least one of the classified queued transactions per each of the channels, the representative transaction per each of the channels may be uncompressed and individual transactions per each of the channels resulting from the uncompression or blocks including said individual transactions may be recorded in the distributed ledgers.

Meanwhile, in the present disclosure, if each of the blockchains networks per each of the channels corresponds to each of different service servers providing each of different services, the transaction-managing server 100 may manage the transactions such that the transactions are linked with a single cryptocurrency accepted by each of the different service servers. Meanwhile, in FIGS. 2A and 2B, it is assumed that a single cryptocurrency is used in the blockchain networks, however, multiple different cryptocurrencies may be used in the blockchain networks, or each of the different blockchain networks per each of the channels may be used for each of the different services with the single cryptocurrency. That is, each of the blockchain networks per each of the channels according to the multiple services may correspond to each of the cryptocurrencies. In this case, the transaction-managing server 100 in accordance with the present disclosure may manage the transactions such that the transactions are linked with the multiple different cryptocurrencies, may allow the multiple different cryptocurrencies to be circulated in the different service servers independently using each of the cryptocurrencies, and may allow the different service servers to use the different blockchain networks per each of the channels for each of the cryptocurrencies.

By referring to FIG. 3 again, procedures for transaction processing of the transaction-managing server are described in detail as follows.

If the requests for registering the transactions are acquired, the transaction-managing server 100 in accordance with the present disclosure may perform a format validation which determines each of first validities representing whether each of the transactions has a format conforming to a certain protocol. The format validation determines whether each of the transactions is qualified for recording in the blockchain networks in response to the requests from the external services. And a format of messages, which are transmitted and received by service providers using the blockchain networks in accordance with the present disclosure, following the certain protocol is validated. Herein, because the validation uses an asynchronous process, information on a recent block and information not yet recorded in a block may be combined to be used for the validation. As a result, the transaction-managing server 100 may guarantee each integrity of the transactions to be recorded in the blockchain networks, and processes hereinafter may be performed under an assumption that the transactions requested for registering in the blockchain networks are without any errors.

Also, the transaction-managing server 100 may perform a content validation which determines each of second validities representing whether each of contents in each of the transactions is valid. For example, in a match between A and B of a P2P-typed game, if A wins 100 points and B loses 100 points, whether B has a balance equal to or greater than 100 points may be validated. If the balance of B is less than 100 points, the transaction-managing server 100 may transmit a signal representing an exception, before registering the transaction in the blockchain networks per each of the channels, to a service server which requested registration of the transaction.

Also, according to a result of the format validation, the transaction-managing server 100 may determine which of the queued transactions is to be stored in which of the blockchain networks per each of the channels and may classify the queued transactions by the channels. That is, after confirming integrities of the transactions, the transaction-managing server 100 may generate one or more queues for registering the transactions with confirmed integrities in the blockchain networks, and may sequentially put the generated queues in a clustered queue. Because it is predetermined for each of the services that which of the transactions will be recorded in which channel of the blockchain networks, the format validation may determine which of the blockchain networks per each of the channels will store which of the queued transactions, and the classified queued transactions may be stored in the queues per each of the channels.

Herein, the clustered queue may include multiple queues capable of holding the transactions per each of the services, and the transaction-managing server 100 may sequentially put the classified queued transactions in their corresponding queues per each of the channels. Herein, the queues may be distributed in a clustering structure physically and logically. Herein, the transaction-managing server 100 may store the classified queued transactions in a first storage part, for example, in a memory, in a physically and logically distributive clustering structure, and if any error, including an overflow, occurs in the first storage part, may physically store the classified queued transactions in a second storage part, for example, in an internal storage such as a hard disk drive or a memory disk, to prevent losses of the transactions.

Meanwhile, to improve performance of recording the transactions in the blockchain networks, the transaction processing method in accordance with the present disclosure may group a certain number of the transactions for each of the blockchain networks into a single transaction, thus minimizing the number of the transactions to be processed. For example, the transaction-managing server 100 may instruct each of the blockchain networks per each of the channels to copy the classified queued transactions per each of the blockchain networks in the clustered queue by a unit of the certain number and convert them into a representative transaction per each of the channels. That is, at least one of the classified queued transactions per each of the channels may be converted, e.g., compressed, into the representative transaction per each of the channels. The converted representative transaction per each of the channels may be a single transaction including an array of original individual transactions. Herein, the transaction-managing server 100 may instruct each of the blockchain networks per each of the channels to convert said at least one of the classified queued transactions per each of the channels into the representative transaction per each of the channels, by either a unit of a certain time interval or a unit of a certain number of the classified queued transactions.

The representative transaction resulting from grouping one or more of the transactions by the unit of the certain time interval or the unit of the certain number may undergo a validating process of the blockchain networks by consensus nodes of the blockchain networks. That is, the transaction-managing server 100 may instruct each of the blockchain networks per each of the channels to proceed with a process of the distributive consensus on the representative transaction per each of the channels.

Then, the transaction-managing server 100 may instruct each of the blockchain networks per each of the channels to convert the consensus-reached representative transaction per each of the channels into each of individual transactions. For example, if the multiple transactions per each of the channels are compressed into the single representative transaction per each of the channels, the transaction-managing server 100 may instruct each of the blockchain networks per each of the channels to uncompress the compressed representative transaction per each of the channels, to thereby acquire the original individual transactions per each of the channels. Then, the transaction-managing server 100 may instruct each of the blockchain networks per each of the channels to allow at least one block including at least one of the original individual transactions to be registered in each of the distributed ledgers corresponding to said each of the blockchain networks per each of the channels.

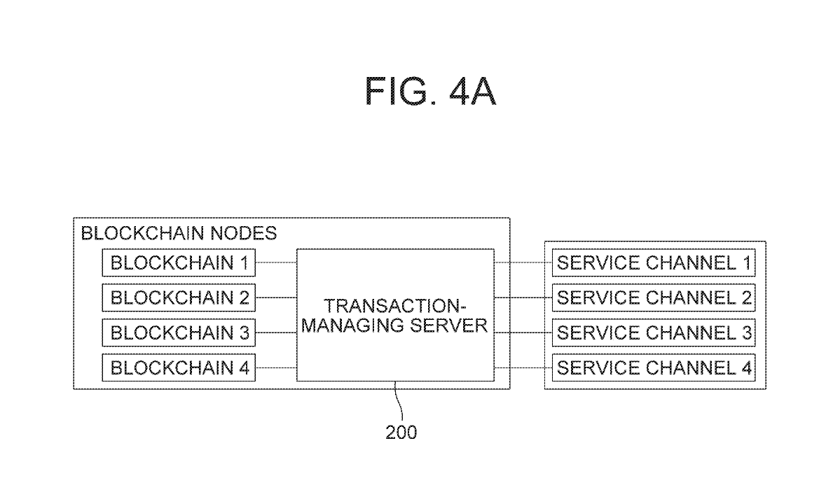

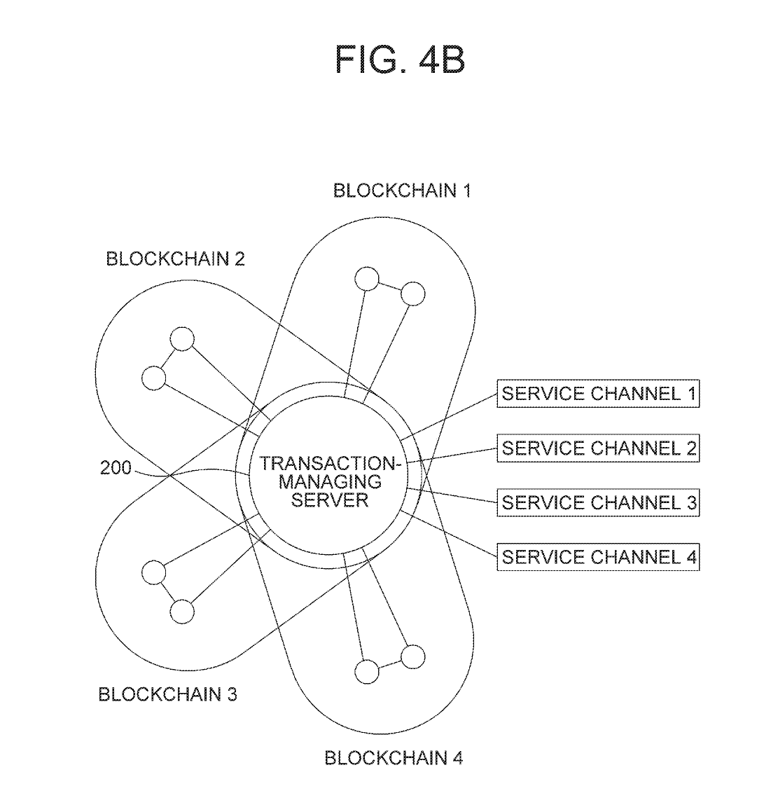

FIG. 4A is a drawing schematically illustrating a configuration of storing the classified transactions per service in the blockchain networks in accordance with another example embodiment of the present disclosure. FIG. 4B is a drawing schematically illustrating the configuration of FIG. 4A in the blockchain network structure in accordance with another example embodiment of the present disclosure.

By referring to FIGS. 4A and 4B, a transaction-managing server 200 in accordance with another example of the present disclosure may function as a single blockchain node, unlike the transaction-managing server 100 shown in FIGS. 2A and 2B. In this case, blockchain nodes corresponding to one of the cryptocurrencies shown in FIGS. 4A and 4B may include nodes corresponding to the transaction-managing server 200 and nodes corresponding to each of the blockchain networks, i.e., the blockchain 1 to the blockchain 4, corresponding to each of the services or each of the service channels, and the transaction-managing server 200 may store the classified queued transactions, classified by each of the services, in their corresponding distributed ledgers.

The transaction-managing server 200 in accordance with another example of the present disclosure may be the single blockchain node simultaneously included in the multiple blockchain networks, as shown in FIG. 4B. That is, the transaction-managing server 200 may be a node in the blockchain 1, and at the same time, may also be a node in the blockchain 2, a node in the blockchain 3, and a node in the blockchain 4. And these multiple blockchain networks may be connected with one or more service servers and may receive the requests for registering the transactions from the different service channels. Meanwhile, unlike this case, as mentioned in said one example embodiment, only the requests for registering the transactions from a single service may be managed, and the transactions may be recorded in each of the distributed ledgers of the blockchain networks per each of the channels corresponding to the different channels within the single service. Also, each of the blockchain 1 to the blockchain 4 may be implemented as a single physical blockchain network, and may be implemented as each of logical blockchain networks within the single physical blockchain network.

Also, the transaction-managing server 200 in accordance with another example of the present disclosure may form at least one of the blockchain nodes, and if the requests for registering the transactions are acquired from one or more service servers, may confirm the validities of the transactions. Herein, when confirming the validities of the transactions, the transaction-managing server 200 may classify the transactions which are determined as valid such that each of the valid transactions corresponds to each channel of the blockchain networks. Then, the transaction-managing server 200 may record the classified queued transactions, classified as corresponding to the blockchain networks per each of the channels, in each of the distributed ledgers per each of the channels, i.e., a distributed ledger 1 to a distributed ledger 4. Herein, the transaction-managing server 200 may convert at least one of the classified queued transactions per each of the channels into at least one representative transaction per each of the channels, e.g., compress said at least one of the classified queued transactions per each of the channels into at least one compressed transaction, and if the distributive consensus on the converted representative transaction per each of the channels is determined as reached, may allow (i) at least one block including said at least one of the classified queued transactions per each of the channels or (ii) each of the classified queued transactions per each of the channels corresponding to said at least one representative transaction per each of the channels to be registered in at least one of the distributed ledgers per each of the channels. Herein, if the representative transaction per each of the channels is the compressed transaction converted from said at least one of the classified queued transactions per each of the channels, the transaction-managing server 200 may uncompress the representative transaction per each of the channels, to thereby acquire and record the resulting original individual transactions per each of the channels or blocks of the resulting original individual transactions per each of the channels in the distributed ledgers per each of the channels. Such processes are similar to the description by referring to FIG. 3.

And, the transaction-managing server 200 may copy the classified queued transactions per each of the blockchain networks in the clustered queue by a unit of the certain number and convert them into the representative transaction per each of the channels. That is, at least one of the classified queued transactions per each of the channels may be converted into the representative transaction per each of the channels. The converted representative transaction per each of the channels may be a single transaction including an array of original individual transactions. Herein, the transaction-managing server 200 may convert said at least one of the classified queued transactions per each of the channels into the representative transaction per each of the channels, by either a unit of the certain time interval or a unit of the certain number of the classified queued transactions.

And, the transaction-managing server 200 may proceed with a process of the distributive consensus on the representative transaction per each of the channels, and may convert the consensus-reached representative transaction per each of the channels into each of the original individual transactions. For example, if the multiple transactions per each of the channels are compressed into the single representative transaction per each of the channels, the transaction-managing server 200 may uncompress the compressed representative transaction per each of the channels, to thereby acquire the original individual transactions per each of the channels. Then, the transaction-managing server 200 may allow at least one block including at least one of the original individual transactions to be registered in each of the distributed ledgers corresponding to said each of the blockchain networks per each of the channels.

Accordingly, the transaction processing method and the transaction-managing server may guarantee high TPS, i.e., transaction per second, that can be used in game services by resolving a problem of low TPS of conventional public blockchain networks. Also, performance may be improved and influence of one service on another service may be minimized by using private blockchain networks which process ledgers or blockchains in a distributive manner, per each of the services.

For example, as aforementioned, in case that the requests for registering the transactions Tx(A-1), Tx(A-2), . . . , etc. are acquired from the service channel 1, that the requests Tx(B-1), Tx(B-2), . . . , etc. are acquired from the service channel 2, and that the requests Tx(C-1), Tx(C-2), . . . , etc. are acquired from the service channel 3, and if an order of acquisition of the requests for registering in the private blockchain networks or the public blockchain networks is Tx(A-1), Tx(B-1), Tx(A-2), Tx(C-1), Tx(B-2), then the transaction-managing server may record the transactions Tx(A-1), Tx(A-2), . . . , etc. requested by the service channel 1 in the distributed ledger of the blockchain of channel 1 corresponding to the service channel 1, may record the transactions Tx(B-1), Tx(B-2), . . . , etc. requested by the service channel 2 in the distributed ledger of the blockchain of channel 2 corresponding to the service channel 2, and may record the transactions Tx(C-1), Tx(C-2), . . . , etc. requested by the service channel 3 in the distributed ledger of the blockchain of channel 3 corresponding to the service channel 3, therefore, no failure occurs during transaction-processing by other service channels, even if the service channel 2 shows a failure or even if processing of the transaction Tx(B-2) requested by the service channel 2 is delayed.

Also, the transaction processing method and the transaction-managing server in accordance with the present disclosure may provide a modularized structure preventing a bug or a security problem occurring in a service connected with a channel from spreading to other channels and reducing a total probability of failures, by isolating channels or blockchain networks per each of the channels.

The present disclosure has an effect of guaranteeing the high TPS by classifying the transactions by the channels corresponding to the characteristics of the transactions and registering the classified transactions in the blockchain networks per each of the channels.

The present disclosure has another effect of improving transaction performance via fast transaction-processing by the blockchain networks with the high TPS.

The present disclosure has still another effect of improving performance of the blockchain networks and minimizing influence of one service on another service by processing ledgers or blockchain networks in a distributive manner, per each of the services when providing multiple services using a single blockchain platform.

The present disclosure has still yet another effect of providing the modularized structure preventing a bug or a security problem occurring in a service connected with a channel from spreading to other channels and reducing the total probability of failures, by isolating the channels or the blockchain networks per each of the channels.

The embodiments of the present invention as explained above can be implemented in a form of executable program command through a variety of computer means recordable to computer readable media. The computer readable media may include solely or in combination, program commands, data files, and data structures. The program commands recorded to the media may be components specially designed for the present invention or may be usable to a skilled human in a field of computer software. Computer readable media include magnetic media such as hard disk, floppy disk, and magnetic tape, optical media such as CD-ROM and DVD, magneto-optical media such as floptical disk and hardware devices such as ROM, RAM, and flash memory specially designed to store and carry out program commands. Program commands include not only a machine language code made by a complier but also a high level code that can be used by an interpreter etc., which is executed by a computer. The aforementioned hardware device can work as more than a software module to perform the action of the present invention and they can do the same in the opposite case.

As seen above, the present invention has been explained by specific matters such as detailed components, limited embodiments, and drawings. They have been provided only to help more general understanding of the present invention. It, however, will be understood by those skilled in the art that various changes and modification may be made from the description without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A method of handling one or more transactions using one or more blockchain networks, comprising steps of:
(a) a transaction-managing server, if one or more requests for registering one or more transactions are acquired, confirming each of one or more validities of each of said one or more transactions and queueing each of said one or more transactions in case it is determined as valid;
(b) the transaction-managing server classifying the queued transactions to be registered in the blockchain networks such that each of the queued transactions corresponds to each of the blockchain networks per each of channels; and
(c) the transaction-managing server, by transmitting each of the classified queued transactions to each of the blockchain networks per each of the channels, instructing each of the blockchain networks per each of the channels to convert at least one of the classified queued transactions per each of the channels into at least one representative transaction per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in at least one of distributed ledgers.

2. The method of claim 1, wherein the step of (c) includes steps of:
(c1) the transaction-managing server instructing each of the blockchain networks per each of the channels to convert at least one of the classified queued transactions per each of the channels into the representative transaction per each of the channels;
(c2) the transaction-managing server instructing each of the blockchain networks per each of the channels to proceed with a process of the distributive consensus on the representative transaction per each of the channels;
(c3) the transaction-managing server instructing each of the blockchain networks per each of the channels to convert the consensus-reached representative transaction per each of the channels into each of individual transactions; and
(c4) the transaction-managing server instructing each of the blockchain networks per each of the channels to allow at least one block including at least one of the individual transactions to be registered in each of the distributed ledgers corresponding to said each of the blockchain networks per each of the channels.

3. The method of claim 2, wherein, at the step of (c1), the transaction-managing server converts the classified queued transactions per each of the channels into the representative transaction per each of the channels by either a unit of a certain time interval or a unit of a certain number of the classified queued transactions.

4. The method of claim 1, wherein, if each of the blockchain networks per each of the channels corresponds to each of different service servers providing each of different services, the transaction-managing server manages said one or more transactions such that said one or more transactions are linked with a single cryptocurrency accepted by each of the different service servers.

5. The method of claim 1, wherein, at the step of (a), the transaction-managing server performs at least part of (i) a format validation which determines each of first validities representing whether each of said one or more transactions has a format conforming to a certain protocol and (ii) a content validation which determines each of second validities representing whether each of contents in each of said one or more transactions is valid.

6. The method of claim 5, wherein, at the step of (b), the transaction-managing server, according to a result of the format validation, determines which of the queued transactions is to be stored in which of the blockchain networks per each of the channels and classifies the queued transactions by a unit of the channels.

7. The method of claim 6, wherein the transaction-managing server stores, in a physically and logically distributive clustering structure, the classified queued transactions in a first storage part, and if an overflow occurs in the first storage part, physically stores the classified queued transactions in a second storage part.

8. A method of handling one or more transactions using one or more blockchain networks, comprising steps of:
(a) a transaction-managing server which functions as at least one of blockchain nodes, if one or more requests for registering one or more transactions are acquired, confirming each of one or more validities of each of said one or more transactions and queueing each of said one or more transactions in case it is determined as valid;
(b) the transaction-managing server classifying the queued transactions to be registered in the blockchain networks such that each of the queued transactions corresponds to each of distributed ledgers per each of channels; and
(c) the transaction-managing server converting at least one of the classified queued transactions per each of the channels into at least one representative transaction per each of the channels by referring to each of the classified queued transactions classified as corresponding to each of the distributed ledgers per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in each of the distributed ledgers per each of the channels.

9. The method of claim 8, wherein the step of (c) includes steps of:
(c1) the transaction-managing server converting at least one of the classified queued transactions per each of the channels into the representative transaction per each of the channels;
(c2) the transaction-managing server proceeding with a process of the distributive consensus on the representative transaction per each of the channels;
(c3) the transaction-managing server converting the consensus-reached representative transaction per each of the channels into each of individual transactions; and
(c4) the transaction-managing server allowing at least one block including each of the individual transactions to be registered in each of the distributed ledgers per each of the channels corresponding to the block.

10. The method of claim 8, wherein, if each of the distributed ledgers per each of the channels corresponds to each of different service servers providing each of different services, the transaction-managing server manages said one or more transactions such that said one or more transactions are linked with a single cryptocurrency accepted by each of the different service servers.

11. The method of claim 8, wherein, at the step of (a), the transaction-managing server performs at least part of (i) a format validation which determines each of first validities representing whether each of said one or more transactions has a format conforming to a certain protocol and (ii) a content validation which determines each of second validities representing whether each of contents in each of said one or more transactions is valid.

12. The method of claim 11, wherein, at the step of (b), the transaction-managing server, according to a result of the format validation, determines which of the queued transactions is to be stored in which of the blockchain networks per each of the channels and classifies the queued transactions by the channels.

13. A transaction-managing server for handling one or more transactions using one or more blockchain networks, comprising:
at least one memory that stores instructions; and
at least one processor configured to execute the instructions to perform or support another device to perform processes of: (I) if one or more requests for registering one or more transactions are acquired, confirming each of one or more validities of each of said one or more transactions and queueing each of said one or more transactions in case it is determined as valid, (II) classifying the queued transactions to be registered in the blockchain networks such that each of the queued transactions corresponds to each of the blockchain networks per each of channels, and (III) by transmitting each of the classified queued transactions to each of the blockchain networks per each of the channels, instructing each of the blockchain networks per each of the channels to convert at least one of the classified queued transactions per each of the channels into at least one representative transaction per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in at least one of distributed ledgers.

14. The transaction-managing server of claim 13, wherein the process of (III) includes processes of:
(III-1) instructing each of the blockchain networks per each of the channels to convert at least one of the classified queued transactions per each of the channels into the representative transaction per each of the channels,
(III-2) instructing each of the blockchain networks per each of the channels to proceed with a process of the distributive consensus on the representative transaction per each of the channels,
(III-3) instructing each of the blockchain networks per each of the channels to convert the consensus-reached representative transaction per each of the channels into each of individual transactions, and
(III-4) instructing each of the blockchain networks per each of the channels to allow at least one block including at least one of the individual transactions to be registered in each of the distributed ledgers corresponding to said each of the blockchain networks per each of the channels.

15. The transaction-managing server of claim 14, wherein, at the process of (III-1), the processor converts the classified queued transactions per each of the channels into the representative transaction per each of the channels by either a unit of a certain time interval or a unit of a certain number of the classified queued transactions.

16. The transaction-managing server of claim 13, wherein, if each of the blockchain networks per each of the channels corresponds to each of different service servers providing each of different services, the processor manages said one or more transactions such that said one or more transactions are linked with a single cryptocurrency accepted by each of the different service servers.

17. The transaction-managing server of claim 13, wherein, at the process of (I), the processor performs at least part of (i) a format validation which determines each of first validities representing whether each of said one or more transactions has a format conforming to a certain protocol and (ii) a content validation which determines each of second validities representing whether each of contents in each of said one or more transactions is valid.

18. The transaction-managing server of claim 17, wherein, at the process of (II), the processor, according to a result of the format validation, determines which of the queued transactions is to be stored in which of the blockchain networks per each of the channels and classifies the queued transactions by a unit of the channels.

19. The transaction-managing server of claim 18, wherein the processor stores, in a physically and logically distributive clustering structure, the classified queued transactions in a first storage part, and if an overflow occurs in the first storage part, physically stores the classified queued transactions in a second storage part.

20. A transaction-managing server, which functions as at least one of blockchain nodes, for handling one or more transactions using one or more blockchain networks, comprising:
at least one memory that stores instructions; and
at least one processor configured to execute the instructions to perform or support another device to perform processes of: (I) if one or more requests for registering one or more transactions are acquired, confirming each of one or more validities of each of said one or more transactions and queueing each of said one or more transactions in case it is determined as valid, (II) classifying the queued transactions to be registered in the blockchain networks such that each of the queued transactions corresponds to each of distributed ledgers per each of channels, and (III) converting at least one of the classified queued transactions per each of the channels into at least one representative transaction per each of the channels by referring to each of the classified queued transactions classified as corresponding to each of the distributed ledgers per each of the channels, and if a distributive consensus on the converted representative transaction per each of the channels is determined as reached, allowing at least one block including said at least one of the classified queued transactions per each of the channels corresponding to said at least one representative transaction per each of the channels to be registered in each of the distributed ledgers per each of the channels.

21. The transaction-managing server of claim 20, wherein the process of (III) includes processes of:
(III-1) converting at least one of the classified queued transactions per each of the channels into the representative transaction per each of the channels,
(III-2) proceeding with a process of the distributive consensus on the representative transaction per each of the channels,
(III-3) converting the consensus-reached representative transaction per each of the channels into each of individual transactions, and
(III-4) allowing at least one block including each of the individual transactions to be registered in each of the distributed ledgers per each of the channels corresponding to the block.

22. The transaction-managing server of claim 20, wherein, if each of the distributed ledgers per each of the channels corresponds to each of different service servers providing each of different services, the processor manages said one or more transactions such that said one or more transactions are linked with a single cryptocurrency accepted by each of the different service servers.

23. The transaction-managing server of claim 20, wherein, at the process of (I), the processor performs at least part of (i) a format validation which determines each of first validities representing whether each of said one or more transactions has a format conforming to a certain protocol and (ii) a content validation which determines each of second validities representing whether each of contents in each of said one or more transactions is valid.

24. The transaction-managing server of claim 23, wherein, at the process of (II), the processor, according to a result of the format validation, determines which of the queued transactions is to be stored in which of the blockchain networks per each of the channels and classifies the queued transactions by a unit of the channels.
